(19) United States
(12) Patent Application Publication
(10) Pub. No.: US 2018/0170331 A1
(43) Pub. Date: Jun. 21, 2018

(54) VEHICLE BRAKING MODE FOR COMPETITIVE DRIVING

(71) Applicant: GM GLOBAL TECHNOLOGY OPERATIONS LLC, Detroit, MI (US)

(72) Inventors: Christopher J. Barber, West Bloomfield, MI (US); Michael F. Tung, Ann Arbor, MI (US)

(73) Assignee: GM GLOBAL TECHNOLOGY OPERATIONS LLC, Detroit, MI (US)

(21) Appl. No.: 15/384,456

(22) Filed: Dec. 20, 2016

(51) Int. Cl. B60T 8/26; B60T 8/176

(52) U.S. Cl. CPC B60T 8/26; B60T 2270/10; B60T 2201/06; B60T 8/176

(57) ABSTRACT

A braking system for a vehicle has a first axle with a first road wheel arranged proximate a first vehicle end, and a second axle with a second road wheel arranged proximate a second vehicle end. The braking system includes a first brake assembly configured to apply a braking force to the first road wheel and a second brake assembly configured to apply a braking force to the second road wheel. The braking system additionally includes a controller for regulating the braking force of each of the first and second brake assemblies. Furthermore, the braking system includes a switch for communicating a request to the controller to apply the braking force via the first brake assembly when the vehicle is in motion, but not via the second brake assembly. The request from the switch is intended to stop rotation and generate a slide of the first road wheel.

### INTRODUCTION

The present disclosure relates to a vehicle braking system having an operating mode for competitive driving.

A brake is typically a mechanical device designed to inhibit motion. Brakes commonly use friction to convert kinetic energy into heat, though other methods of energy conversion may be employed. On vehicles, braking systems are employed to apply a retarding force, typically via frictional elements at the vehicle's rotating axles or wheels, to inhibit vehicle motion. Friction brakes often include stationary shoes or pads that are lined with friction material and configured to be engaged with a rotating wear surface, such as a rotor or a drum. Common configurations include shoes that contact to rub on the outside of a rotating drum, commonly called a “band brake”, a rotating drum with shoes that expand to rub the inside of a drum, commonly called a “drum brake”, and pads that pinch a rotating disc, commonly called a “disc brake”.

A typical motor vehicle also employs a parking brake to keep the vehicle stationary. The most common parking brake is a mechanically latching brake that maintains its engagement until deactivated via a dedicated release mechanism. Some modern vehicles use an electric motor, rather than a lever, to engage the parking brake in response to a push or pull of a button. In a majority of vehicles, the parking brake operates on the rear wheels, although some vehicles have used parking brakes that operate on the front wheels. Although the most common use for a parking brake is to keep the vehicle motionless when it is parked, parking brakes may also be used to assist the vehicle operator during hill starts, especially on vehicles with manual transmissions. Such use of the parking brake frees both of driver's feet for use on the accelerator and the clutch pedals, allowing the car to move from rest without rolling back.

### SUMMARY

A braking system is disclosed for a vehicle having a first axle that includes a first road wheel arranged proximate a first vehicle end, and a second axle that includes a second road wheel arranged proximate a second vehicle end. The braking system includes a first brake assembly operatively connected to the first road wheel and configured to apply a braking force to the first road wheel. The braking system also includes a second brake assembly operatively connected to the second road wheel and configured to apply a braking force to the second road wheel. The braking system additionally includes a controller configured to regulate application of the braking force via each of the first and second brake assemblies. Furthermore, the braking system includes a switch configured to communicate a request to the controller to apply the braking force to the first road wheel via the first brake assembly when the vehicle is in motion relative to a road surface, but not to the second road wheel via the second brake assembly. The request from the switch is intended to stop rotation and generate a slide of the first road wheel relative to the road surface.

The braking system may also include a fluid source configured to supply a pressurized fluid to each of the first and second brake assemblies and thereby apply the braking force at the respective first and second road wheels. The controller may then be in operative communication with the fluid source and configured to regulate a release of the pressurized fluid from the fluid source to the first and second brake assemblies.

The request to the controller to apply the first braking force to the first road wheel via the switch may be a request to release the pressurized fluid to the first brake assembly, but not to the second brake assembly.

The braking system may additionally include a first hydraulic passage fluidly connecting the fluid source to the first brake assembly and a second hydraulic passage fluidly connecting the fluid source to the second brake assembly.

The fluid source may include a fluid pump in fluid communication with the first brake assembly via the first hydraulic passage. The controller may then be configured to operate the fluid pump to apply the first braking force via the first brake assembly in response to the request from the switch to stop rotation and generate a slide of the first road wheel relative to the road surface.

The braking system may also include an anti-lock braking system (ABS) module operatively connected to the controller. In such a case, the fluid pump may be configured as an ABS pump incorporated into the ABS module. The braking system may further include a brake master cylinder actuated via a brake pedal, in fluid communication with the ABS module, and configured to supply the fluid to the ABS module.

The ABS module may include a first valve configured to control a flow of the pressurized fluid through the first hydraulic passage to apply the first braking force via the first brake assembly and a second valve configured to control a flow of the pressurized fluid through the second hydraulic passage to apply the second braking force via the second brake assembly. In such a case, the controller may be configured to open the first valve to apply the first braking force via the first brake assembly, but not open the second valve to apply the second braking force via the second brake assembly, in response to the request from the switch to stop rotation and generate a slide of the first road wheel relative to the road surface.

The braking system may also include an actuator, such as a linear or a rotary actuator, and/or an electric/screw motor. The first actuator may be configured to engage the first brake assembly to apply the braking force at the first road wheel. The controller may also be configured to operate the first actuator to engage the first brake assembly in response to the request from the switch to stop rotation and generate a slide of the first road wheel relative to the road surface.

The switch may be an electronic parking brake switch configured, i.e., arranged and constructed, to be triggered by an operator of the vehicle to engage a parking brake function via the first brake assembly.

The first vehicle end may be a rear end of the vehicle and the first road wheel may be a rear wheel of the vehicle. Additionally, the vehicle may include two first road wheels. The braking system may include two first brake assemblies operatively connected to the respective first road wheels. In such a case, the controller may be configured to apply the braking force to both first road wheels concurrently via the respective first brake assemblies when the vehicle is in motion relative to the road surface in response to the request from the switch.

A vehicle employing the above braking system is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic plan view of a motor vehicle having front and rear axles with respective front and rear road wheels, a vehicle braking system, and a switch for actuation by a driver of the vehicle for stopping rotation of the rear road wheels according to the disclosure. (GM3424)

FIG. 2 is a schematic cross-sectional view of a brake subassembly that is part of the braking system shown in FIG. 1, wherein the brake subassembly is configured as a disc brake.

FIG. 3 is a schematic side view of a brake subassembly that is part of the braking system shown in FIG. 1, wherein the brake subassembly is configured as a drum brake and includes a brake shoe with a friction segment.

FIG. 4 is a schematic close-up view of one embodiment of the vehicle braking system in communication with the switch shown in FIG. 1.

FIG. 5 is a schematic close-up view of another embodiment of the vehicle braking system in communication with the switch shown in FIG. 1.

FIG. 6 is a schematic close-up view of yet another embodiment of the vehicle braking system in communication with the switch shown in FIG. 1.

### DETAILED DESCRIPTION

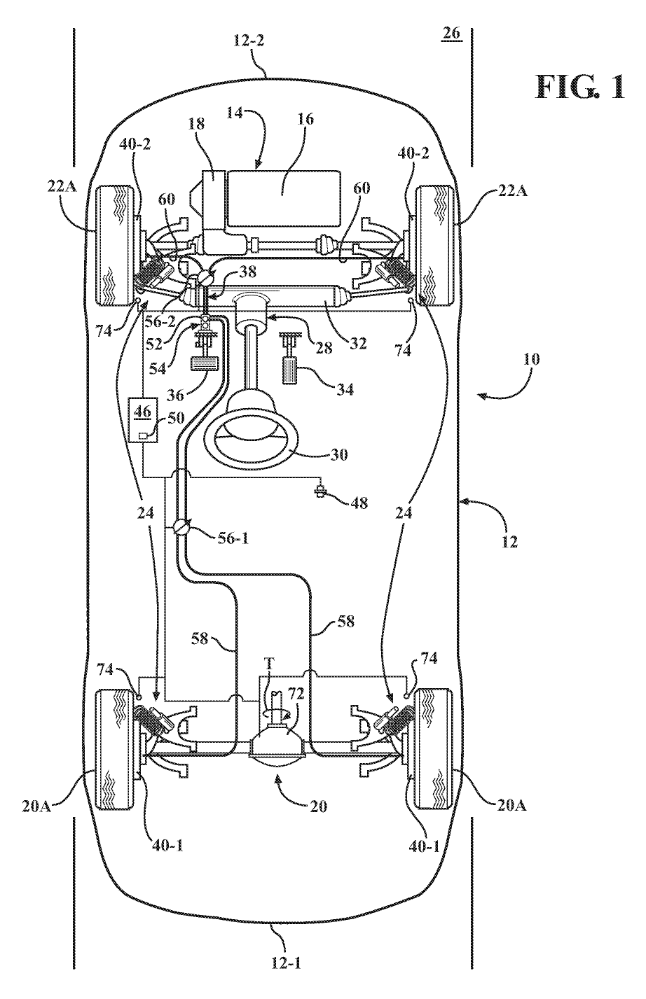

Referring to the drawings, wherein like reference numbers refer to like components, FIG. 1 shows a schematic view of a motor vehicle 10, which includes a vehicle body 12. The vehicle body 12 includes a first vehicle body end or rear end 12-1 and a second vehicle body end or front end 12-2 opposite of the first vehicle body end. The vehicle 10 also includes a powertrain 14 configured to propel the vehicle. As shown in FIG. 1, the powertrain 14 includes an engine 16 and a transmission 18. The powertrain 14 may also include one or more motor/generators as well as a fuel cell, neither of which are shown, but a powertrain configuration employing such devices is appreciated by those skilled in the art. Generally, the vehicle 10 also includes an energy storage device (not shown), such as one or more batteries, configured to accept an electric charge and supply electric current to operate various vehicle systems, including the powertrain 14.

The vehicle 10 also includes a first drive axle 20 including a plurality or set of first or rear road wheels 20A arranged proximate the rear end 12-1 and a second drive axle 22 including a plurality or set of second or front road wheels 22A arranged proximate the front end 12-2. Although four wheels, i.e., a pair of first or rear wheels 20A and a pair of second or front wheels 22A, are shown in FIG. 1, a vehicle with fewer or greater number of either front or rear wheels is also envisioned. As shown, a vehicle suspension system 24 operatively connects the body 12 to the rear and front wheels 20A, 22A for maintaining contact between the wheels and a road surface 26, and for maintaining handling of the vehicle. Although in FIG. 1 the suspension system 24 is shown to include upper and lower control arms along with respective springs and dampers, other configurations of the suspension system 24 are similarly envisioned.

As shown in FIG. 1, a vehicle steering system 28 is operatively connected to the front wheels 22A for steering the vehicle 10. The steering system 28 includes a steering wheel 30 that is operatively connected to the front wheels 22A via a steering rack 32. The steering wheel 30 is arranged inside the passenger compartment of the vehicle 10, such that an operator of the vehicle may command the vehicle to assume a particular direction with respect to the road surface 26. Additionally, an accelerator pedal 34 and a brake pedal 36 are each positioned inside the passenger compartment of the vehicle 10. The accelerator pedal 34 is operatively connected to the powertrain 14 for commanding propulsion of the vehicle 10, while the brake pedal 36 is operatively connected to a vehicle braking system 38, and each is adapted to be controlled by the operator of the vehicle.

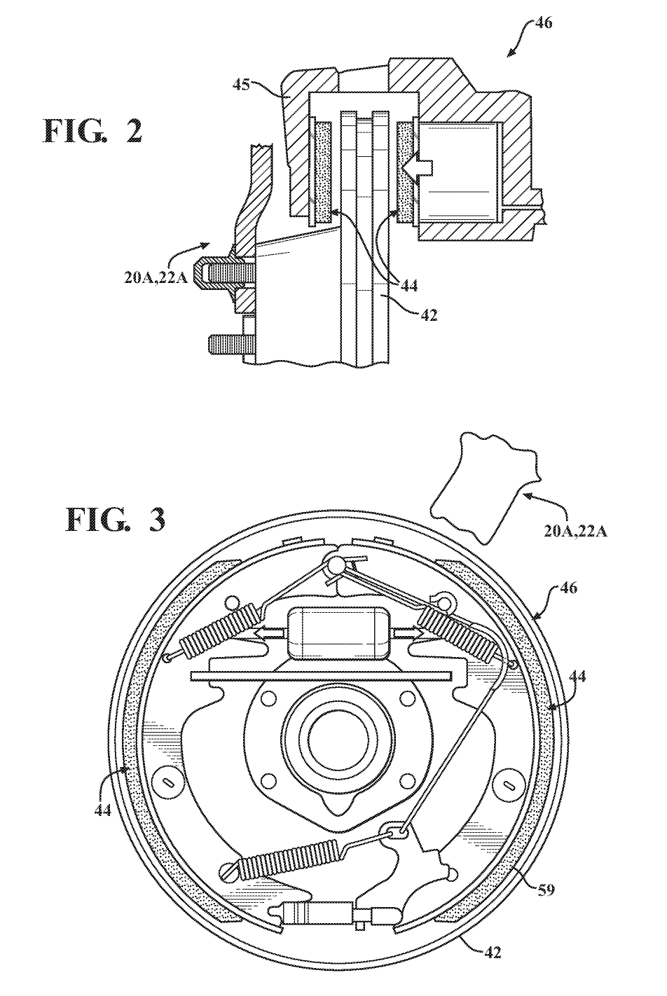

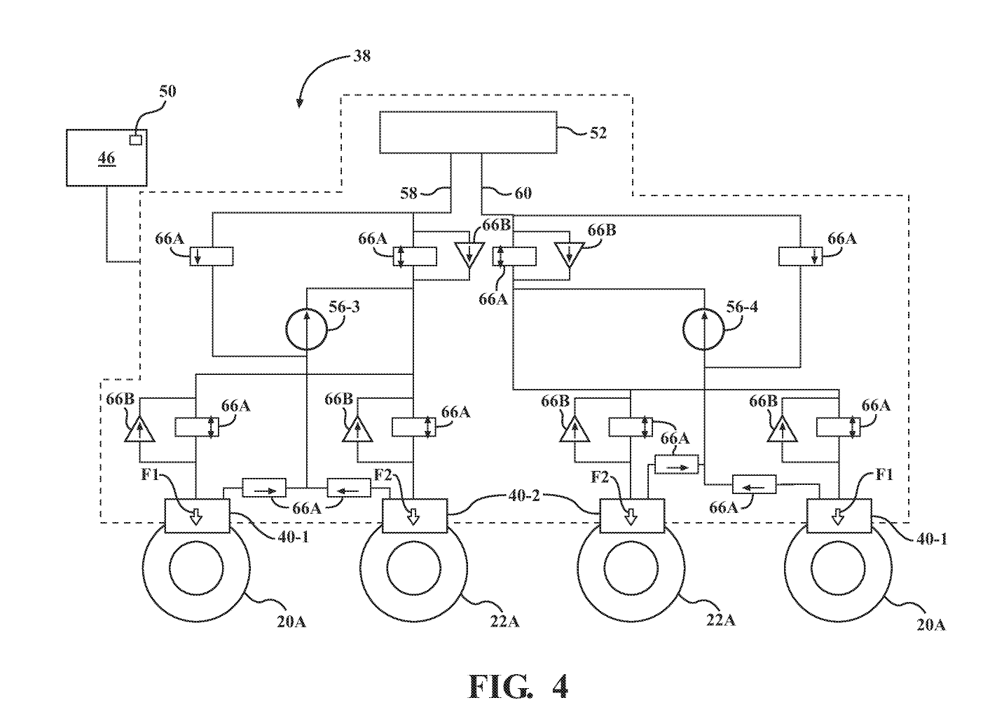

As shown in FIG. 1, the braking system 38 is operatively connected to the wheels 20A, 22A for decelerating the vehicle 10. The braking system 38 includes two first or rear brake assemblies 40-1, each first brake assembly being operatively connected to a respective rear road wheel 20A and configured to apply a first braking force F1 to the subject rear road wheel 20A to retard rotation thereof. The braking system 38 also includes two second or front brake assemblies 40-2, each second brake assembly being operatively connected to a respective front road wheel 20B and configured to apply a second braking force F2 to the subject front road wheel 22A to retard rotation thereof. As shown in FIG. 2, each brake assembly 40-1, 40-2 is arranged at what is generally termed a suspension and braking “corner” of the vehicle. Each brake assembly 40-1, 40-2 may be configured as either a disc brake (shown in FIG. 2) or a drum brake (shown in FIG. 3). As shown in each of the FIGS. 2 and 3, each brake assembly 40-1, 40-2 includes a rotor 42 configured for synchronous rotation with the respective wheel 20A, 22A.

With continued reference to FIGS. 2 and 3, each brake assembly 40-1, 40-2 also includes friction elements 44 configured to be selectively engaged with the rotor 42 to apply the respective braking force F1, F2, and thereby retard rotation of the corresponding wheel 20A, 22A. The friction element 44 is typically called a “brake pad” or “brake shoe”. As shown in FIG. 2, if either of the brake assemblies 40-1, 40-2 is configured as a disc brake, the respective rotor 42 is configured as a disc rotor and the friction elements 44 are correspondingly configured as disc brake pads held movably in a caliper 45. In the event either of the brake assemblies 40-1, 40-2 is configured as a drum brake, as shown in FIG. 3, the respective rotor 42 is configured as a brake drum and the friction elements 44 are correspondingly configured as drum brake shoes housed within a hub assembly. Although the remainder of the disclosure deals specifically with the disc brake configuration of the brake assemblies 40-1, 40-2, those skilled in the art will recognize that the disclosure is equally applicable to that of drum brakes.

The braking system 38 also includes a controller 46 operatively connected to the first and second brake assemblies 40-1, 40-2 and configured to regulate selective engagement and disengagement of each of the first and second brake assemblies. The controller 46 may be configured as an electronic control unit (ECU) or a dedicated electronic brake control module (EBCM) for regulating operation of the braking system 38, or include a central processing unit (CPU) that, in addition to the braking system, regulates various functions and/or systems of the vehicle 10. In order to appropriately control operation of the braking system 38, the controller 46 includes a memory, at least some of which is tangible and non-transitory. The memory may be an appropriate recordable medium that participates in providing computer-readable data or process instructions. Such a medium may take many forms, including but not limited to non-volatile media and volatile media.

Non-volatile media for the controller 46 may include, for example, optical or magnetic disks and other persistent memory. Volatile media may include, for example, dynamic random access memory (DRAM), which may constitute a main memory. Such instructions may be transmitted by one or more transmission medium, including coaxial cables, copper wire and fiber optics, including the wires that comprise a system bus coupled to a processor of a computer. Memory of the controller 46 may also include a floppy disk, a flexible disk, hard disk, magnetic tape, another magnetic medium, a CD-ROM, DVD, another optical medium, etc. The controller 46 may be configured or equipped with other required computer hardware, such as a high-speed clock, requisite Analog-to-Digital (A/D) and/or Digital-to-Analog (D/A) circuitry, necessary input/output circuitry and devices (I/O), as well as appropriate signal conditioning and/or buffer circuitry. Algorithms required by the controller 46 or accessible thereby may be stored in the memory and automatically executed to provide the required functionality.

The braking system 38 also includes a switch 48 configured to communicate a request 50 to the controller 46 to apply the first braking force F1 to the rear road wheels 20A via the first brake assemblies 40-1 when the vehicle 10 is in motion relative to the road surface 26. According to the present disclosure, in the vehicle 10 having two rear road wheels 20A, the controller 46 is configured to apply the braking force F2 to both rear road wheels concurrently or substantially simultaneously via the respective first brake assemblies 40-1 in response to the request 50 from the switch 48. The request 50 is, however, not used by the controller 46 to apply the second braking force F2 via the second brake assemblies 40-2 to the front wheels 22A. As a result, the application of the second braking force F2 in response to the request 50 will stop rotation and generate a slide of only the rear road wheels 20A relative to the road surface 26. Specifically, the switch 48 may be an electronic parking brake switch configured to be activated or triggered by an operator of the vehicle 10 to engage a parking brake function via the first brake assemblies 40-1 generally intended to keep the vehicle stationary.

A traditional parking brake is a fully mechanical system having a cable connected to the brake mechanism on one end that is pulled on another end directly by a hand-operated lever or a foot-operated pedal located in a vehicle cabin. A mechanical parking brake typically also includes a ratchet locking mechanism designed to keep the parking brake engaged until deactivated via a dedicated release mechanism. A mechanical parking brake, especially the hand-operated lever or handbrake type, may be used in competitive driving, for example to initiate a vehicle drift or to quickly negotiate a very tight bend, such as in rallying, by turning the vehicle around within the vehicle's own turning circle, typically referred to as a handbrake turn. A more recent variation of parking brakes is an electrically actuated, or electronic parking brake. In a more-traditional cable-pulling type of the electric parking brake, an electric motor is configured to pull a brake cable in response to a push or pull of a button, such as the switch 48, rather than via a mechanical hand-operated lever or a foot-operated pedal. In a yet further development of the electronic parking brake, an individual computer-controlled motor may be mounted to a respective rear brake caliper for actuation thereof. An electric parking brake system sometimes incorporates a hill-hold function used to prevent vehicle roll-back when stopping and starting on a hill.

As shown in FIG. 1, the braking system 38 also includes a fluid source configured to supply a pressurized brake fluid 54 to each of the first brake assemblies 40-1 and thereby apply the first braking forces F1. The specific fluid source may be a hydraulic reservoir and/or booster 52, a.k.a., a master brake cylinder. The fluid source may also include fluid pumps 56-1 and 56-2, as shown in FIG. 1, and fluid pumps 56-3 and 56-4, as shown in FIG. 4, each in fluid communication with the master brake cylinder 52. The master brake cylinder 52 is typically actuated by the operator via the brake pedal 36, while the respective fluid pump(s) may draw the brake fluid 54 from the master brake cylinder and further pressurize the fluid. The master brake cylinder 52 with the respective fluid pumps is additionally configured to supply the pressurized fluid 54 to each of the second brake assemblies 40-2 and thereby apply the second braking force F2. As shown in FIGS. 1 and 4, the braking system 38 may include hydraulic passages 58 and 60 fluidly connecting the master brake cylinder 52 and the respective fluid pumps to the respective first and second brake assemblies 40-1, 40-2.

As shown in FIG. 1, the controller 46 may be in operative communication with the master brake cylinder 52 and configured to regulate a release of the pressurized fluid 54 from the master brake cylinder to the first and second brake assemblies 40-1, 40-2 by actuating the fluid pumps 56-1 and 56-2 when the operator of the vehicle 10 applies the brake pedal 36. As shown in FIG. 4, the controller 46 may be configured to regulate a release of the pressurized fluid 54 from the master brake cylinder to the first and second brake assemblies 40-1, 40-2 by actuating the fluid pumps 56-3 and 56-4 when the operator of the vehicle 10 applies the brake pedal 36. According to the disclosure, the request 50 to the controller 46 to apply the first braking force F1 to the rear road wheels 20A via the switch 48 may be a request to release the pressurized fluid 54 to each of the first brake assemblies 40-1 from the fluid pump 56-1, but not to the second brake assemblies 40-2.

As shown in FIG. 1, the braking system 38 may have one fluid pump 56-1 fluidly connecting the master brake cylinder 52 with both first brake assemblies 40-1, for example via the hydraulic passages 58, and have another fluid pump 56-2 fluidly connecting the master brake cylinder 52 with both second brake assemblies 40-2 via the hydraulic passages 60. Such an embodiment of the braking system 38 is typically referred to as a front-rear hydraulic split system. As shown in FIG. 4, one fluid pump 56-3 fluidly connects the master brake cylinder 52 with one of the first brake assemblies 40-1 and one of the second brake assemblies 40-2 via the hydraulic passages 58. Also in FIG. 4, another fluid pump 56-4 fluidly connects the master brake cylinder 52 with the other of the first brake assemblies 40-1 and the other of the second brake assemblies 40-2 via the hydraulic passages 60. The embodiment of the braking system 38 shown in FIG. 4 is typically referred to as a diagonal split system.

In either FIG. 1 or FIG. 4, at least one fluid pump, either pump 56-1 or pump 56-3, is in fluid communication with at least one first brake assembly 40-1 via the respective first hydraulic passage 58. While in FIG. 1 the system requires only the pump 56-1 to operate when only the first brake assemblies 40-1 need to be engaged, in FIG. 4 the system requires both pumps 56-3 and 56-4 to operate to engage only the first brake assemblies 40-1. Accordingly, the controller 46 is configured to operate the fluid pump 56-1 in the embodiment of FIG. 1 and both fluid pumps 56-3, 56-4 in the embodiment of FIG. 4 to apply the first braking force F1 via the first brake assemblies 40-1 in response to the request 50 from the switch 48 to stop rotation and generate a slide of the rear road wheels 20A relative to the road surface 26.

The structural difference between the FIG. 1 and FIG. 4 embodiments of the braking system 38 may necessitate separate arrangement of valves to ensure appropriate actuation of the first brake assemblies 40-1, but not the second brake assemblies 40-2 in response to the activation of the switch 48. For example, as shown in FIG. 4, the braking system 38 may include a plurality of on-off valves 66A to control flow of the brake fluid 54 through a respective fluid passage 58 or 60 from the respective fluid pump 56-3, 56-4, and a plurality of one-way valves 66B to prevent reverse flow of the brake fluid. Each of the on-off valves 66A may be regulated via the controller 46 to achieve the desired actuation of the first and second brake assemblies 40-1, 40-2 during regular system operation, and actuation of only the first brake assemblies 40-1 in response to the activation of the switch 48. The one-way valves 66B may either be regulated by the controller 46 or be configured as passive check-valves.

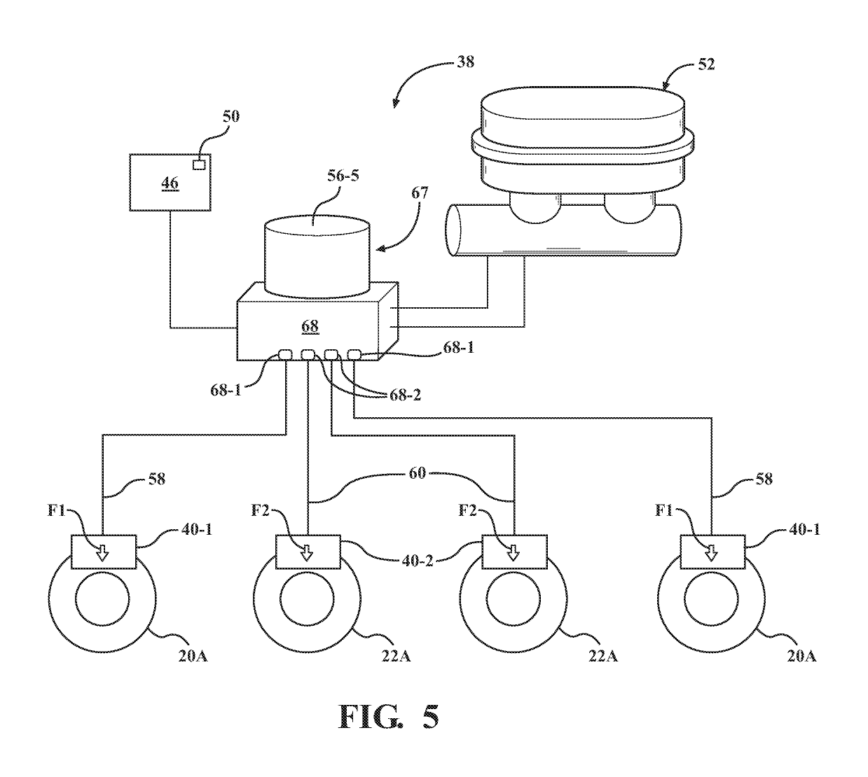

As shown in FIG. 5, the braking system 38 may additionally include an anti-lock braking system (ABS) module 67 operatively connected to the controller 46. In the embodiment of the braking system 38 having the ABS module 67, one fluid pump 56-5, configured as an ABS pump incorporated into the ABS module may be used to provide pressurized brake fluid to each of the first brake assemblies 40-1 and the second brake assemblies 40-2 via respective hydraulic passages 58 and 60. In such a braking system 38, the brake master cylinder 52 may be in fluid communication with and configured to supply the brake fluid 54 to the ABS module 67. The ABS module 67 may include a valve block 68 including a plurality of first valves 68-1 configured to control a flow of the pressurized brake fluid 54 through the first hydraulic passages 58 to apply the first braking force F1 via the first brake assemblies 40-1. Additionally, the valve block 68 includes a plurality of second valves 68-2 configured to control a flow of the pressurized fluid through the second hydraulic passage 60 to apply the second braking force F2 via the second brake assemblies 40-2. In such a construction of the braking system 38, the controller 46 may be configured to open the first valves 68-1 to apply the first braking force F1 via the first brake assemblies 40-1, but not open the second valve 68-2 to apply the second braking force F2 via the second brake assemblies 40-2, in response to the request from the switch 48 to stop rotation and generate a slide of the rear road wheels 20A relative to the road surface 26.

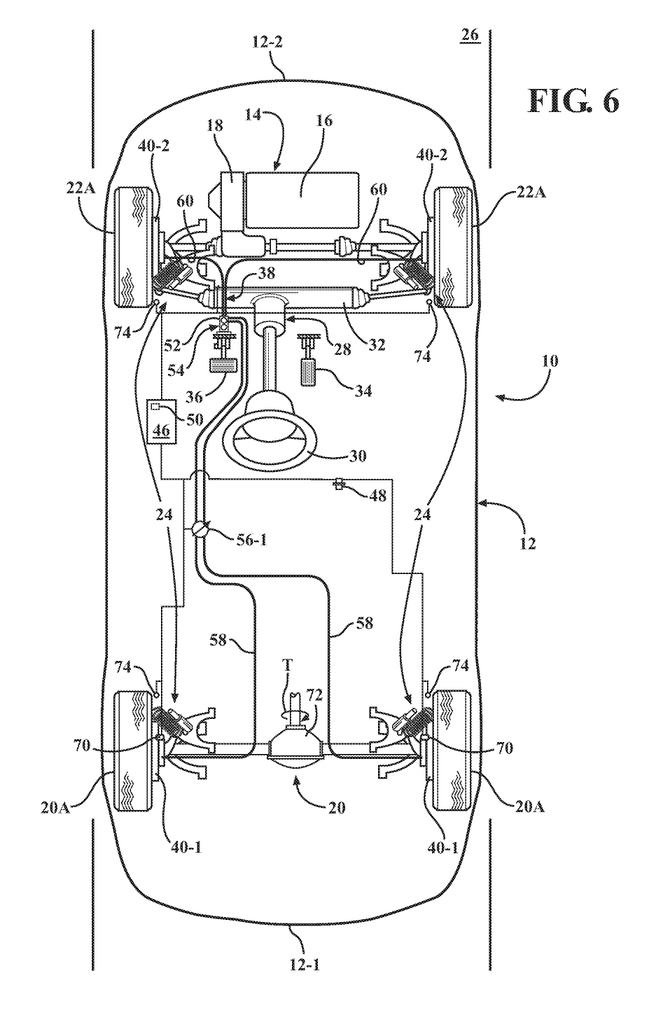

Alternatively, in a separate embodiment shown in FIG. 6, the braking system 38 may include an individual actuator 70 at each first brake assembly 40-1. In such an embodiment, the actuators 70 are configured to engage the respective first brake assemblies 40-1 to thereby apply the first braking force F1 at each of the rear road wheels 20A. Each actuator 70 may be a direct acting linear or rotary actuator, an electric screw motor, or another mechanism configured to transfer the respective first braking force F1 to an individual first brake assembly 40-1. In yet another embodiment, the braking system 38 may include a single actuator 70 configured to transfer the respective first braking force F1 simultaneously to all the first brake assemblies 40-1, such as via a cable system (not shown). In either of such embodiments, the controller 46 may be configured to operate the actuators 70 to engage the first brake assemblies 40-1 in response to the request 50 from the switch 48 to stop rotation and generate a slide of the rear road wheels 20A relative to the road surface 26.

As additionally shown in FIGS. 1 and 6, if the rear wheels 20A are configured to receive drive torque T from the powertrain 14, the vehicle 10 may also include an electronic, i.e., electronically controlled, limited slip differential (eLSD) 72. As shown, the eLSD 72 is arranged at the first drive axle 20 and is configured to apportion drive torque T at the first drive axle between the rear wheels 20A. The eLSD 72 is configured to limit the difference in angular velocity between the rear wheels 20A whenever one of the rear wheels becomes unloaded or otherwise loses traction. Accordingly, useful torque T may be transmitted to the road surface 26 as long as some traction is generated by at least one of the rear wheels 20A. The eLSD 72 may include a friction plate clutch (not shown) that is configured to apportion the drive torque T between the rear wheels 20A in response to tractive effort and relative speeds of the rear wheels 20A.

Operation of the eLSD 72 is regulated by the controller 46 in response to the operation of the powertrain 14 and the tractive effort of the rear wheels 20A. The controller 46 may also be configured to fully couple the eLSD 72 prior to or in parallel with commencing application of the first braking force F1 via the actuators 70 when the switch 48 is activated, such that the rear wheels may apply braking forces to the road surface 26 substantially synchronously and evenly. Additionally, if the vehicle 10 is equipped with electronic stability control (ESC), the ESC may also be shut off for the duration of the actuation of the switch 48. The controller 46 may also inform the driver of the vehicle 10, for example via a visual indicator on a vehicle instrument cluster (not shown), when eLSD 72 coupling and/or ESC shut-off has been enabled.

With continued reference to FIGS. 1 and 6, the braking system 38 may additionally include one or more vehicle sensors 74 in electronic communication with the controller 46. According to the disclosure, each vehicle sensor 74 is configured to detect a vehicle operating parameter, such as a rotating speed of a particular road wheel 20A, 22A. In such a case, the controller 46 may be additionally configured to individually regulate the first brake assemblies 40-1 and adjust dynamic behavior of the vehicle 10 in response to the request 50 from the switch 48, while taking into consideration the detected vehicle operating parameter, such as the rotating speed(s) of the road wheel(s) 20A, 22A. For example, the controller 46 may be programmed to apply the first braking force F1 via one or both of the actuators 70, if the detected rotating speed of the rear road wheels 20A is greater than the detected rotating speed of the front road wheels 22A. Additionally the controller 46 may regulate the actuators 70 to apply the first braking force F1 and thereby stop the rotation of the rear road wheel(s) 20A to permit the vehicle 10 to execute a handbrake turn or to commence a drift—techniques that may be used in motorsport, such as in rallying and drifting. Accordingly, response to actuation of the switch 48 may be configured to simulate operation of a mechanical handbrake.

Traditionally, in a handbrake turn, a driver of the vehicle starts by using steering input to transfer weight to the tires on the outside of the corner. The handbrake is then used to lock the rear wheels, thus upsetting the adhesion between the tires and the road surface. With practice, the vehicle may be placed accurately by releasing the handbrake and accelerating the vehicle. Also, pulling the handbrake is the easiest way to start a drift, but also causes a significant loss of speed at the exit of the corner. Therefore, in the context of auto racing, such technique is most commonly used in rallying. In rallying, racers often use handbrake turning to quickly negotiate tight corners that would otherwise require a three-point maneuver to go through. Although the handbrake turn is sometimes used in motorsport, the technique turn may also be used in certain other applications, such as stunt or pursuit driving. In pursuit driving, the technique may be used for turning the car around in the width of two lanes without using a three-point maneuver, for example to bewilder a pursuer. For stunt purposes, parallel parking may be completed in a single motion using the handbrake, such as to demonstrate the driver's control of the vehicle and/or the vehicle's agility.

In a normal turn, rear wheels 20A follow the front wheels 22A because frictional resistance in the forward direction, i.e., where the wheels turn, is significantly less than in the sideways direction, such that the sideways resistance provides the centripetal force that makes the rear end 12-1 of the vehicle 10 follow the turn. However, when the driver locks the rear wheels 20A with the first brake assemblies 40-1, both forward and sideways directions provide the same frictional resistance. As a result, vehicle inertia tends to keep the rear end 12-1 of the vehicle 10 moving in the original direction, which causes the rear end to slide out. Accordingly, the dynamic behavior of the vehicle 10 may be modified in response to the request of the vehicle driver by the controller 46 applying the first braking force F1 at the rear road wheels 20A to initiate a slide at the rear end 12-1.

The controller 46 may also continue regulating the actuators 70 to apply the first braking force F1 while monitoring the rotating speeds of the road wheel(s) 20A, 22A and sustained activation of the switch 48. To such an end, the controller 46 may be programmed with a look-up table 76 of rotating speeds of the road wheel(s) 20A, 22A and/or the difference between the rotating speeds of the front and rear wheels versus the first braking force F1 to thereby permit application of the first braking force in correspondence with the assessed slip at each of the road wheel(s) 20A, 22A and/or the difference between those speeds. The controller 46 may also regulate application of the first braking force F1 via the actuators 70 by monitoring dynamic behavior of the vehicle 10 represented by signals from yaw sensor(s) and acceleration sensor(s) (not shown) configured to detect the respective yaw and lateral and/or longitudinal acceleration of the vehicle. The controller 46 may also discontinue application of the first braking force F1 via the actuators 70 when a signal from the switch 48 has been interrupted or suspended.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

1. A braking system for a vehicle having a first axle that includes a first road wheel arranged proximate a first vehicle end, and a second axle that includes a second road wheel arranged proximate a second vehicle end, the braking system comprising:
a first brake assembly operatively connected to the first road wheel and configured to apply a first braking force to the first road wheel;
a second brake assembly operatively connected to the second road wheel and configured to apply a second braking force to the second road wheel;
a controller configured to regulate application of the first and second braking forces via the respective first and second brake assemblies; and
an electronic parking brake switch configured to be triggered by an operator of the vehicle to engage a parking brake function via the first brake assembly and configured to communicate a request to the controller to apply the first braking force to the first road wheel via the first brake assembly when the vehicle is in motion relative to a road surface, but not to the second braking force via the second brake assembly, and thereby stop rotation and generate a slide of the first road wheel relative to the road surface.

2. The braking system according to claim 1, further comprising a fluid source configured to supply a pressurized fluid to each of the first and second brake assemblies and thereby apply the respective first and second braking forces, wherein the controller is in operative communication with the fluid source and configured to regulate a release of the pressurized fluid from the fluid source to the first and second brake assemblies.

3. The braking system according to claim 2, wherein the request to the controller to apply the first braking force to the first road wheel via the switch is a request to release the pressurized fluid to the first brake assembly, but not to the second brake assembly.

4. The braking system according to claim 2, further comprising a first hydraulic passage fluidly connecting the fluid source to the first brake assembly and a second hydraulic passage fluidly connecting the fluid source to the second brake assembly.

5. The braking system according to claim 4, wherein the fluid source includes a fluid pump in fluid communication with the first brake assembly via the first hydraulic passage, and wherein the controller is configured to operate the fluid pump to apply the first braking force via the first brake assembly in response to the request from the switch to stop rotation and generate a slide of the first road wheel relative to the road surface.

6. The braking system according to claim 5, further comprising an anti-lock braking system (ABS) module operatively connected to the controller, wherein the fluid pump is configured as an ABS pump incorporated into the ABS module.

7. The braking system according to claim 6, wherein:
the ABS module includes a first valve configured to control a flow of the pressurized fluid through the first hydraulic passage to apply the first braking force via the first brake assembly and a second valve configured to control a flow of the pressurized fluid through the second hydraulic passage to apply the second braking force via the second brake assembly; and
the controller is configured to open the first valve to apply the first braking force via the first brake assembly, but not open the second valve to apply the second braking force via the second brake assembly, in response to the request from the switch to stop rotation and generate a slide of the first road wheel relative to the road surface.

8. The braking system according to claim 1, further comprising a first actuator configured to engage the first brake assembly to apply the first braking force at the first road wheel, and wherein the controller is configured to operate the first actuator to engage the first brake assembly in response to the request from the switch to stop rotation and generate a slide of the first road wheel relative to the road surface.

9. (canceled)

10. The braking system according to claim 1, wherein the first vehicle end is a rear end of the vehicle and the first road wheel is a rear wheel of the vehicle, and wherein the vehicle includes two first road wheels, the braking system comprising two of the first brake assemblies operatively connected to the respective first road wheels, and wherein the controller is configured to apply the braking force to both first road wheels concurrently via the respective first brake assemblies when the vehicle is in motion relative to the road surface in response to the request from the switch.

11. A vehicle comprising:
a vehicle body including a first vehicle body end and a second vehicle body end opposite of the first vehicle body end;
a first axle including a first road wheel arranged proximate the first vehicle body end and a second axle including a second road wheel arranged proximate the second vehicle body end; and
a braking system for retarding movement of the vehicle, including:
a first brake assembly operatively connected to the first road wheel and configured to apply a braking force to the first road wheel;
a second brake assembly operatively connected to the second road wheel and configured to apply a braking force to the second road wheel;
a controller configured to regulate application of the braking force via each of the first and second brake assemblies; and
an electronic parking brake switch configured to be triggered by an operator of the vehicle to engage a parking brake function via the first brake assembly, fixed relative to the vehicle body, and configured to communicate a request to the controller to apply the braking force to the first road wheel via the first brake assembly when the vehicle is in motion relative to a road surface, but not to the second road wheel via the second brake assembly, and thereby stop rotation and generate a slide of the first road wheel relative to the road surface.

12. The vehicle according to claim 11, wherein the braking system additionally includes a fluid source configured to supply a pressurized fluid to each of the first and second brake assemblies and thereby apply the braking force at the respective first and second road wheels, wherein the controller is in operative communication with the fluid source and configured to regulate a release of the pressurized fluid from the fluid source to the first and second brake assemblies.

13. The vehicle according to claim 12, wherein the request to the controller to apply the first braking force to the first road wheel via the switch is a request to release the pressurized fluid to the first brake assembly, but not to the second brake assembly.

14. The vehicle according to claim 12, further comprising a first hydraulic passage fluidly connecting the fluid source to the first brake assembly and a second hydraulic passage fluidly connecting the fluid source to the second brake assembly.

15. The vehicle according to claim 14, wherein the fluid source includes a fluid pump in fluid communication with the first brake assembly via the first hydraulic passage, and wherein the controller is configured to operate the fluid pump to apply the first braking force via the first brake assembly in response to the request from the switch to stop rotation and generate a slide of the first road wheel relative to the road surface.

16. The vehicle according to claim 15, wherein the braking system additionally includes an anti-lock braking system (ABS) module operatively connected to the controller, and wherein the fluid pump is configured as an ABS pump incorporated into the ABS module.

17. The vehicle according to claim 16, wherein:
the ABS module includes a first valve configured to control a flow of the pressurized fluid through the first hydraulic passage to apply the first braking force via the first brake assembly and a second valve configured to control a flow of the pressurized fluid through the second hydraulic passage to apply the second braking force via the second brake assembly; and
the controller is configured to open the first valve to apply the first braking force via the first brake assembly, but not open the second valve to apply the second braking force via the second brake assembly, in response to the request from the switch to stop rotation and generate a slide of the first road wheel relative to the road surface.

18. The vehicle according to claim 11, wherein the braking system additionally includes a first actuator configured to engage the first brake assembly to apply the first braking force at the first road wheel, and wherein the controller is configured to operate the first actuator to engage the first brake assembly in response to the request from the switch to stop rotation and generate a slide of the first road wheel relative to the road surface.

19. (canceled)

20. The vehicle according to claim 11, wherein the first vehicle body end is a rear end of the vehicle and the first road wheel is a rear wheel of the vehicle, wherein the vehicle includes two first road wheels, wherein the braking system includes two of the first brake assemblies operatively connected to the respective first road wheels, and wherein the controller is configured to apply the braking force to both first road wheels concurrently via the respective first brake assemblies when the vehicle is in motion relative to the road surface in response to the request from the switch.

21. The braking system according to claim 5, wherein the fluid pump in fluid communication with the first brake assembly via the first hydraulic passage is a first fluid pump, the braking system further comprising a second fluid pump in fluid communication with the second brake assembly via the second hydraulic passage and configured to apply the second braking force via the second brake assembly.

22. The vehicle according to claim 15, wherein the fluid pump in fluid communication with the first brake assembly via the first hydraulic passage is a first fluid pump, the braking system further comprising a second fluid pump in fluid communication with the second brake assembly via the second hydraulic passage and configured to apply the second braking force via the second brake assembly.
